(19) United States
(12) Patent Application Publication
(10) Pub. No.: US 2009/0303569 A1
(43) Pub. Date: Dec. 10, 2009

(54) SELF-TILTED MICROMIRROR DEVICE

(75) Inventors: Gyoung Il Cho, Seoul (KR); Jin Young Sohn, Fullerton, CA (US); Hye Young Kim, Jeonbuk (KR); Cheong Soo Seo, Seongnam (KR)

Correspondence Address: STEREO DISPLAY INC., 980 EAST ORANGETHORPE AVENUE, SUITE F, ANAHEIM, CA, 92801, US

(73) Assignees: Stereo Didplay, Inc., Anaheim, CA (US); Angstrom, Inc., Seongnam (KR)

(21) Appl. No.: 12/124,110

(22) Filed: May 20, 2008

(51) Int. Cl. G02B 26/00

(52) U.S. Cl. 359/290

(57) ABSTRACT

A self-tilted micromirror device of the present invention comprises a plurality of micro-structures including a substrate, at least one stiction plate configured to be attracted to the substrate by adhesion force, a top plate coupled to the stiction plate elastically and configured to have at least one motion when the stiction plate is attracted to the substrate, and at least one pivot structure disposed between the substrate and the top plate and configured to provide a tilting point or area for the motion of the top plate. The motion of the top plate is determined by the geometry of the micro-structures of the self-tilted micromirror device.

### FIELD OF INVENTION

The present invention relates to a self-tilted micromirror device having a motion without external force.

### BACKGROUND OF THE INVENTION

Optical systems are part of everyday life. The optical systems are found in virtually everywhere including in small portable electronics (e.g. digital camera, camcorder, camera phone, webcam), office supplies (e.g. printer, scanner, fax machine), surveillance systems, toys, quality control systems, laboratory and observatory equipments (e.g. telescope, microscope), medical equipments (e.g. endoscope), etc. The conventional lenses used in the optical systems continually face challenge of balancing image quality and production cost. The spherical lenses are widely used since they can be relatively easily fabricated with low cost. The optical systems using them, however, tend to suffer from the aberration problem and in turn produce low quality images. A sort of aspherical lenses configured to remove or reduce aberration can be used for improving image quality. However, the fabricating process of aspherical lenses is time consuming, complicated, and expensive, which hinder the wide use of the aspherical lenses.

Another challenge in the conventional lenses is to make them large. Conventional Fresnel type lenses are a good solution to make large lenses without handling large and heavy materials. However, the image quality of the Fresnel lens is not as good as that of the conventional lens.

To overcome the difficulties in fabricating conventional lenses, lenses using new fabrication methods have been introduced. Gradient index lenses are one example. Instead of using geometrical variation, the variation of refractive index is used to give the same effect in making a lens. Using the refractive index of material and geometrical variation together, the aberration of the optical system can be reduced. Although the gradient index lens gives the significant reduction of the aberration, it is still expensive and difficult to fabricate.

With the rapid growth of the MEMS technology, wide variety MEMS applications have been developed. One of well known application of the MEMS technology is micromirror devices using a plurality of micromirrors; for example, Digital Micromirror Device (DMD) used in the DLP (Digital Light Processing) projection devices. The DMD is an array of several hundred thousand micromirrors, wherein each individual micromirror has the same structure with one another and works as an on-off optical switch. With the success of the DMD technology, many efforts have been made to improve the micromirror devices to provide more advanced features such as multiple step motions, multiple degree of freedom motion, and simple actuation mechanism.

These advance features can be advantageously used to overcome the difficulties in fabricating conventional lenses. One exemplary micromirror device using these features is a Micromirror Array Lens reproducing conventional lenses. The Micromirror Array Lens comprises a plurality of micromirrors configured to have multiple step motions in multiple degrees of freedom and forms at least one optical surface profile by controlling the motions of the micromirrors. Each optical surface profile of the Micromirror Array Lens reproduces a conventional lens. The Micromirror Array Lens can be used as a variable focal length lens having multiple optical surface profiles. The Micromirror Array Lens with variable focal length lens and the properties of the Micromirror Array Lens can be found in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. patent application Ser. No. 11/426,565 filed Jun. 26, 2006, U.S. patent application Ser. No. 11/743,664 filed May 2, 2007, and U.S. patent application Ser. No. 11/933,105 filed Oct. 31, 2007, all of which are incorporated herein by references. Typically, the micromirrors in the Micromirror Array Lens have the same structures with one another, wherein the structure is configured to provide a micromirror with multiple step motions. This structure is favorable when the Micromirror Array Lens reproduces multiple conventional lenses or a variable focal length lens.

Also the general principle, structure and methods for making the discrete motion control of MEMS device are disclosed in U.S. Pat. No. 7,330,297 issued Feb. 12, 2008 to Noh, U.S. Pat. No. 7,365,899 issued Apr. 29, 2008 to Gim, U.S. patent application Ser. No. 10/872,241 filed Jun. 18, 2004, U.S. patent application Ser. No. 11/347,590 filed Feb. 4, 2006, U.S. patent application Ser. No. 11/369,797 filed Mar. 6, 2006, U.S. patent application Ser. No. 11/426,565 filed Jun. 26, 2006, U.S. patent application Ser. No. 11/534,613 filed Sep. 22, 2006, U.S. patent application Ser. No. 11/534,620 filed Sep. 22, 2006, U.S. patent application Ser. No. 11/549,954 filed Oct. 16, 2006, U.S. patent application Ser. No. 11/609,882 filed Dec. 12, 2006, U.S. patent application Ser. No. 11/685,119 filed Mar. 12, 2007, U.S. patent application Ser. No. 11/693,698 filed Mar. 29, 2007, U.S. patent application Ser. No. 11/742,510 filed Apr. 30, 2007, and U.S. patent application Ser. No. 11/762,683 filed Jun. 13, 2007, all of which are incorporated herein by references.

Instead of producing multiple optical surface profiles, the Micromirror Array Lens can be configured to reproduce a single conventional lens or a fixed focal length lens as well. Each micromirror has a required motion to form an optical surface profile but the required motion for each micromirror can be different from others'. When each micromirror is made to have the same structure, the structure still has to be configured to provide each micromirror with multiple motions just like the case of reproducing a variable focal length lens because each micromirror has the different required position. This can make the Micromirror Array Lens have unnecessarily complicated structure and require a control circuitry to control the motions of the micromirrors. In order to simplify the fabrication process and operation, the structure of each micromirror can be customized to have only the required motion.

The present invention provides a new simple and economical micro-device fabrication method providing a required motion without external force by introducing self-tilted micromirror motion.

### SUMMARY OF THE INVENTION

The present invention addresses the problems of the prior art and provides a micro-device having a required motion in a simple and economical way by introducing a self-tilted micromirror device. The geometry of the micro-structures is predetermined so that the self-tilted micromirror device has the required motion. The motion of the self-tilted micromirror device is initiated and maintained without external force. The self-tilted micromirror device of the present invention can be used in many MEMS applications including, but not limited to, the Micromirror Array Lens.

A self-tilted micromirror device of the present invention comprises a plurality of micro-structures including a substrate, at least one stiction plate configured to be attracted to the substrate by adhesion force, a top plate coupled to the stiction plate elastically and configured to have at least one motion when the stiction plate is attracted to the substrate, and at least one pivot structure disposed between the substrate and the top plate and configured to provide a tilting point or area for the motion of the top plate, wherein the motion of the top plate is determined by the geometry of the micro-structures of the self-tilted micromirror device.

The stiction plate is disposed between the substrate and the top plate and connected to the top plate elastically by at least one top plate spring structure. The top plate spring structure can be a torsional spring structure or a flexible beam allowing stiction plate to have a relative rotational motion with respect to the top plate. When the stiction plate is attracted to the substrate, the top plate spring structure is configured to be deformed until the stiction plate contacts the substrate. The top plate spring structure is configured to reduce or minimize the bending of the stiction plate and/or the top plate. The self-tilted micromirror device can further comprise at least one top plate post configured to provide a space between the top plate and the stiction plate and connecting the top plate and the top plate spring structure.

The pivot structure provides a space between the substrate and the top plate to allow the motion of the top plate and a portion of the pivot structure becomes a tilting point or area for the motion of the top plate when the stiction plate is attracted to the substrate. The pivot structure can be disposed on the substrate and configured to contact the top plate when the stiction plate is attracted to the substrate. Also, the pivot structure can be disposed on the top plate and configured to contact the substrate when the stiction plate is attracted to the substrate.

The stiction plate is configured to be attracted to the substrate by adhesion force; for example, adhesion surface forces. As the size of the self-tilted micromirror device decreases to micro-scale, the surface-to-volume ratio increases. Therefore, the effects of surface forces such as capillary force, van der Waals force, atomic bonding force, and electrostatic force by residual charge become significant. In conventional MEMS devices, these adhesion surface forces pose non-trivial problems such as unwanted stiction or collapse of the micro-structures. The present invention utilizes these adhesion surface forces advantageously to make the self-tilted micromirror device have a required motion. In order to increase the amount of the adhesion surface forces, the stiction plate is configured to have a large surface area. Also, a passivation layer can be deposited on the substrate in order to increase the adhesion force.

One of the adhesion surface forces is the capillary force. The capillary action occurred due to liquid used in the releasing process of the micro-structures. The capillary action is caused by adhesive intermolecular force between different substances. The liquid left in the releasing process of the micro-structures adheres to the substrate and stiction plate and draws the stiction plate toward to the substrate. During the drying process, the amount of the liquid between the substrate and the stiction plate decreases and so further does the distance between substrate and the stiction plate. The capillary action can initiate the attraction of the stiction plate.

In addition to capillary action, stiction force including other adhesion surface forces such as van der Waals force, atomic bonding force, and electrostatic force by residual charge are generated. Although the liquid is eventually dried up, these stiction forces keep attracting the stiction plate toward the substrate and eventually make the surfaces of the substrate and the stiction plate contact. The substrate and stiction plate remain in contact if the stiction force is strong enough to overcome restoring force of the deformed micro-structures of the self-tilted micromirror device including the top plate spring structure. The top plate spring structure is configured to be flexible enough such that the stiction force overcomes restoring force caused by the deformation of the top plate spring structure. Then, the top plate can have a fixed position without applying any external force.

The stiction plate is attracted to the substrate in the releasing process of the micro-structures. The stiction plate is attracted to the substrate in the initial operation of the self-tilted micromirror device. The linear and angular position of the top plate remains fixed by the adhesion force after the motion of the top plate.

In order to connect the substrate and the other micro-structures, the self-tilted micromirror device can further comprise at least one support structure. The support structure is disposed on the substrate and connected to the stiction plate elastically. The self-tilted micromirror device can further comprise at least one substrate spring structure connecting the stiction plate and the support structure. The substrate spring structure is configured to be stiff enough to hold the micro-structures in place at the perturbation and flexible enough such that the stiction force can overcome restoring force caused by the deformation of the top plate spring structure and the substrate spring structure to enable the stiction plate to contact the substrate. The pivot structure can be disposed on the top plate and configured to contact the support structure when the stiction plate is attracted to the substrate. Also, the pivot structure can be the support structure configured to contact the top plate when the stiction plate is attracted to the substrate.

To avoid unwanted stiction problems between the top plate and other micro-structures, the self-tilted micromirror device can further comprise at least one dimple structure disposed between the stiction plate and the top plate and configured to provide a space between the stiction plate and the top plate. The dimple structure prevents unnecessary contact between the top plate and other micro-structures of the self-tilted micromirror device.

The linear and angular position of the top plate after the releasing process can be predetermined by the design process of the geometry of the self-tilted micromirror device. In some cases, the motion of the top plate is determined by the contact points between the top plate and the pivot structure and the contact points between the substrate and stiction plate. In some other cases, the motion of the top plate is determined by the contact points between the pivot structure and the substrate and the contact points between the substrate and stiction plate. To change these contact points, the geometry of the micro-structures of the self-tilted micromirror device can be varied. The motion of the top plate is determined by the size of the top plate. The motion of the top plate is determined by the size and position of the pivot structure.

A self-tilted micromirror device comprises a substrate, at least one stiction plate configured to be attracted to the substrate by adhesion force, a top plate configured to have at least one motion when the stiction plate is attracted to the substrate, at least one top plate post configured to provide a space between the top plate and the stiction plate, at least one top plate spring structure connecting the stiction plate and the top plate post, and at least one pivot structure disposed between the substrate and the top plate and configured to provide a tilting point or area for the motion of the top plate, wherein the motion of the top plate is determined by the geometry of the micro-structures.

A self-tilted micromirror device comprises a substrate, at least one stiction plate configured to be attracted to the substrate by adhesion force, a top plate coupled to the stiction plate elastically and configured to have at least one motion when the stiction plate is attracted to the substrate, and at least one pivot structure connecting the substrate and the top plate and configured to be bent and provide a tilting point or area for the motion of the top plate, wherein the motion of the top plate is determined by the geometry of the micro-structures.

A self-tilted micromirror device comprises a substrate, at least one stiction plate configured to be attracted to the substrate by adhesion force, a top plate coupled to the stiction plate elastically and configured to have at least one motion when the stiction plate is attracted to the substrate, at least one pivot structure disposed between the substrate and the top plate and configured to provide a tilting point or area for the motion of the top plate, and at least one support structure disposed on the substrate and connected to the stiction plate by at least one substrate spring structure, wherein the motion of the top plate is determined by the geometry of the micro-structures.

A self-tilted micromirror device comprises a substrate, at least one stiction plate configured to be attracted to the substrate by adhesion force, a top plate connected to the stiction plate by at least one top plate spring structure and configured to have at least one motion when the stiction plate is attracted to the substrate, at least one pivot structure disposed between the substrate and the top plate and configured to provide a tilting point or area for the motion of the top plate, and at least one support structure disposed on the substrate and connected to the stiction plate by at least one substrate spring structure, wherein the motion of the top plate is determined by the geometry of the micro-structures.

A self-tilted micromirror device comprises a substrate, at least one stiction plate configured to be attracted to the substrate by adhesion force, a top plate coupled to the stiction plate elastically and configured to have at least one motion when the stiction plate is attracted to the substrate, at least one pivot structure disposed between the substrate and the top plate and configured to provide a tilting point or area for the motion of the top plate, at least one support structure disposed on the substrate and connected to the stiction plate by at least one substrate spring structure, and at least one dimple structure disposed between the substrate and the top plate and configured to provide a space between the stiction plate and the top plate, wherein the motion of the top plate is determined by the geometry of the micro-structures.

Although the present invention is briefly summarized, the full understanding of the invention can be obtained by the following drawings, detailed description, and appended claims.

### DESCRIPTION OF THE FIGURES

These and other features, aspects and advantages of the present invention will become better understood with reference to the accompanying drawings, wherein:

FIGS. 1A and 1B are schematic diagrams of one embodiment of the present invention illustrating essential components and brief fabrication process;

FIGS. 2A and 2B are schematic diagrams of embodiments of the present invention with variation in geometry of the top plate spring structure;

FIGS. 2C and 2D are schematic diagrams of embodiments of the present invention with variation in disposition of the pivot structure;

FIGS. 2E and 2F are schematic diagrams of embodiments of the present invention with variation in connectivity of the pivot structure;

FIGS. 2G-2I are schematic diagrams of embodiments of the present invention further comprising at least one support structure;

FIG. 2J is a schematic diagram of one embodiment of the present invention further comprising at least one dimple structure;

FIGS. 3A-3E are schematic diagrams of one exemplary embodiment of the present invention illustrating its structure and motion in further detail;

FIGS. 4A-4D are schematic diagrams showing the effects of variation in the effective size of the top plate;

FIGS. 5A-5D are schematic diagrams showing the effects of variation in the position of the pivot structure disposed on the top plate;

FIGS. 6A-6D are schematic diagrams showing the effects of variation in the position of the pivot structure disposed on the substrate;

FIGS. 7A-7D are schematic diagrams showing self-tilted micromirror devices providing the top plates with independent translational motion and rotational motion;

FIGS. 8A-8D are schematic diagrams showing self-tilted micromirror devices providing the top plates with independent translational motion and rotational motion; and

FIGS. 9A-9B are schematic diagrams showing the pivot structures disposed on the outer rim of the top plates or substrates; and

FIGS. 10A-10B are schematic diagrams showing the pivot structures moving through holes in stiction plates.

### DETAILED DESCRIPTION OF THE INVENTION

The present invention will now be described in detail with reference to embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

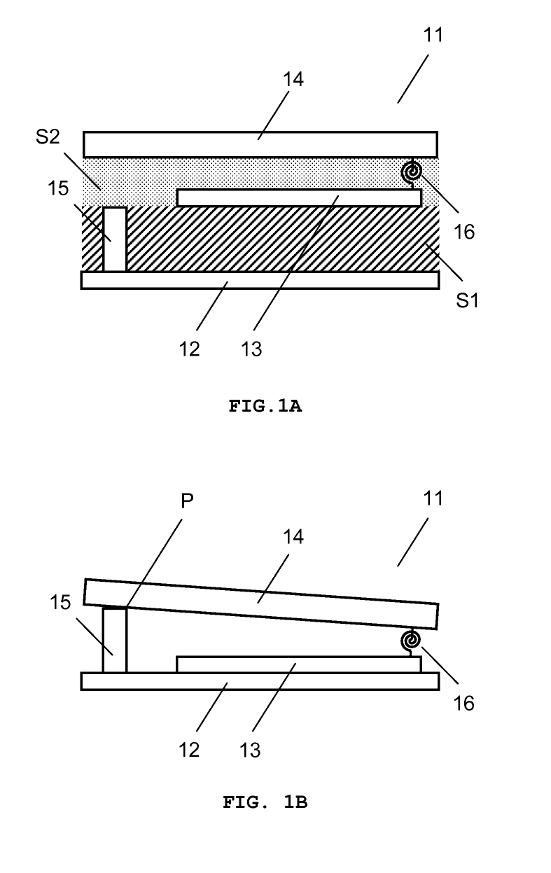

FIGS. 1A and 1B are schematic diagrams of one embodiment of the present invention illustrating the essential components and brief fabrication process of the self-tilted micromirror device of the present invention. A self-tilted micromirror device 11 of the present invention comprises a plurality of micro-structures including a substrate 12, at least one stiction plate 13 configured to be attracted to the substrate 12 by adhesion force, a top plate 14 coupled to the stiction plate 13 elastically and configured to have at least one motion when the stiction plate 13 is attracted to the substrate 12, and at least one pivot structure 15 disposed between the substrate 12 and the top plate 14 and configured to provide a tilting point or area P for the motion of the top plate 14, wherein the motion of the top plate 14 is determined by the geometry of the micro-structures of the self-tilted micromirror device 11. FIGS. 1A and 1B show the self-tilted micromirror device 11 before and after the motion of the top plate 14, respectively.

The stiction plate 13 is disposed between the substrate 12 and the top plate 14 and connected to the top plate 14 elastically by at least one top plate spring structure 16. The top plate spring structure 16 can be a torsional spring structure or a flexible beam allowing stiction plate 13 to have a relative rotational motion with respect to the top plate 14. When the stiction plate 13 is attracted to the substrate 12, the top plate spring structure 16 is configured to be deformed until the stiction plate 13 contacts the substrate 12. The top plate spring structure 16 is configured to reduce or minimize the bending of the stiction plate 13 and/or the top plate 14.

The pivot structure 15 provides a space between the substrate 12 and top plate 14 to allow the motion of the top plate 14 and a portion of the pivot structure 15 becomes a tilting point or area P for the motion of the top plate 14 when the stiction plate 13 is attracted to the substrate 12 as shown in FIG. 1B.

The stiction plate 13 is configured to be attracted to the substrate 12 by adhesion force; for example, adhesion surface forces. As the size of the self-tilted micromirror device 11 decreases to micro-scale, the surface-to-volume ratio increases. Therefore, the effects of surface forces such as capillary force, van der Waals force, atomic bonding force, and electrostatic force by residual charge become significant. In conventional MEMS devices, these adhesion surface forces pose non-trivial problems such as unwanted stiction or collapse of the micro-structures. The present invention utilizes these adhesion surface forces advantageously to make the self-tilted micromirror device 11 have a required motion. In order to increase the amount of the adhesion surface forces, the stiction plate 13 is configured to have a large surface area. Also, a passivation layer can be deposited on the substrate 12 in order to increase the adhesion force.

One of the adhesion surface forces is the capillary force. The capillary action occurred due to liquid used in the releasing process of the micro-structures. The capillary action is caused by adhesive intermolecular force between different substances. The liquid left in the releasing process of the micro-structures adheres to the substrate 12 and stiction plate 13 and draws the stiction plate 13 toward to the substrate 12. During the drying process, the amount of the liquid between the substrate 12 and the stiction plate 13 decreases and so further does the distance between substrate 12 and the stiction plate 13. The capillary action can initiate the attraction of the stiction plate 13.

In addition to capillary action, stiction force including other adhesion surface forces such as van der Waals force, atomic bonding force, and electrostatic force by residual charge are generated. Although the liquid is eventually dried up, these stiction forces keep attracting the stiction plate 13 toward the substrate 12 and eventually make the surfaces of the substrate 12 and the stiction plate 13 contact. The substrate 12 and stiction plate 13 remain in contact if the stiction force is strong enough to overcome restoring force of the deformed micro-structures of the self-tilted micromirror device 11 including the top plate spring structure 16. The top plate spring structure 16 is configured to be flexible enough such that the stiction force overcomes restoring force caused by the deformation of the top plate spring structure 16. Then, the top plate 14 can have a fixed position without applying any external force.

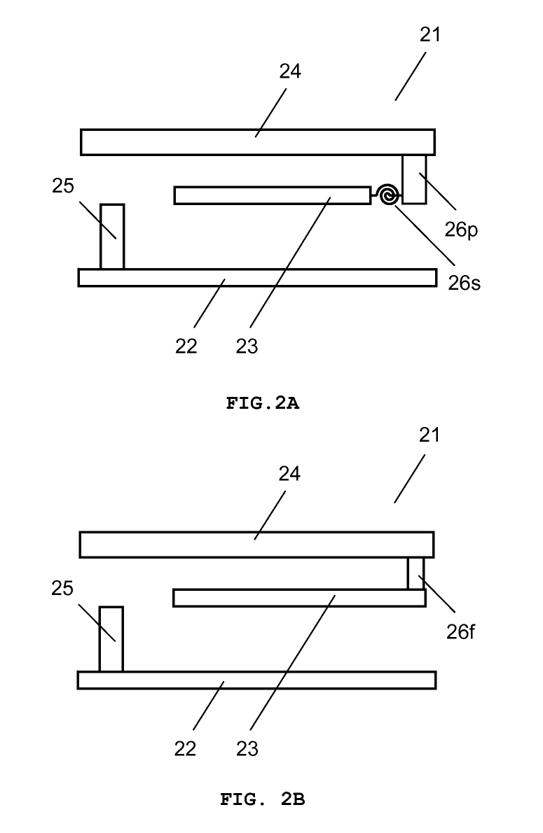

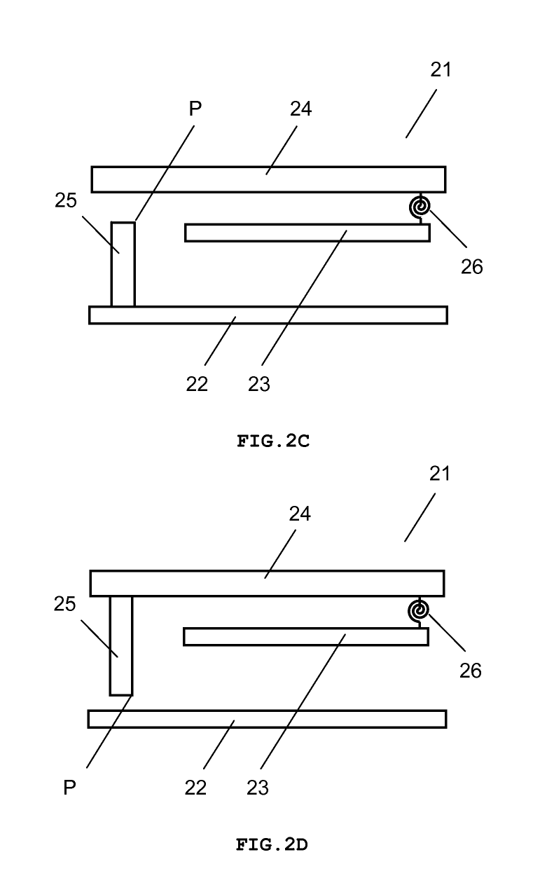

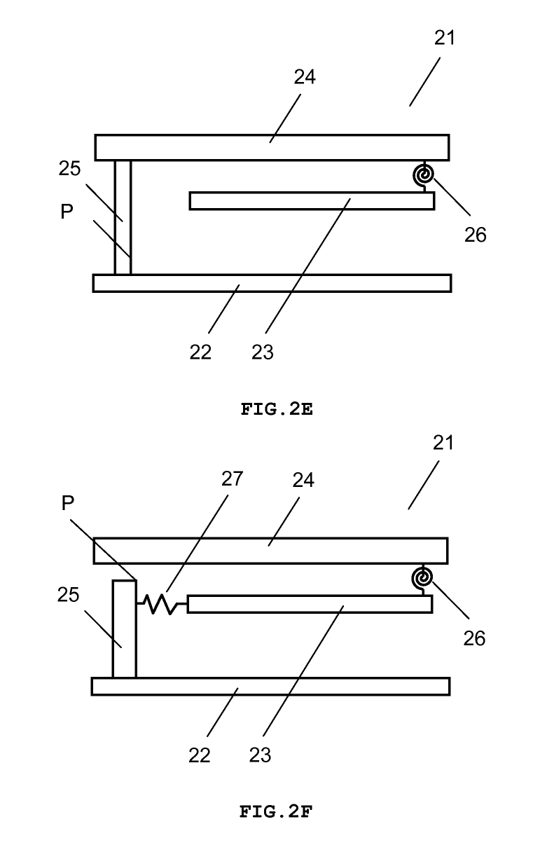

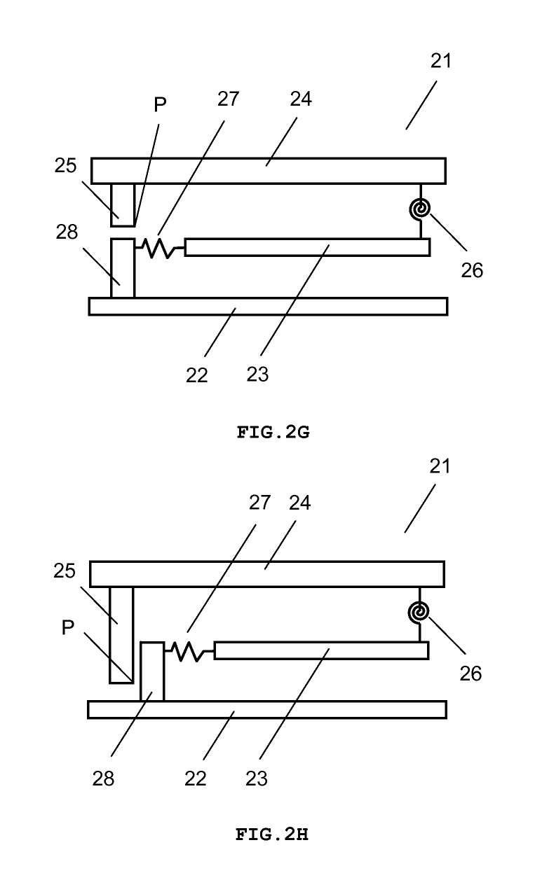

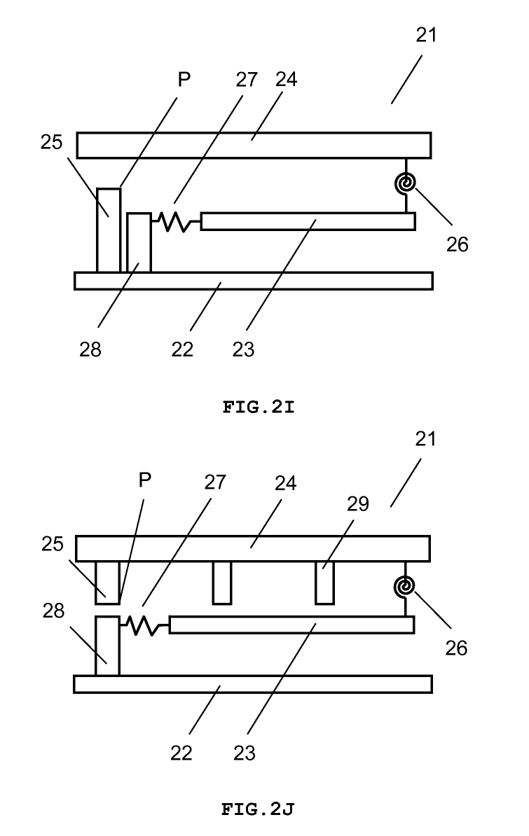

In order to connect the substrate 12 and the other micro-structures, the self-tilted micromirror device 11 can further comprise at least one support structure as will be shown in FIGS. 2G-2J. The support structure is disposed on the substrate 12 and connected to the stiction plate 13 elastically. The self-tilted micromirror device 11 can further comprise at least one substrate spring structure connecting the stiction plate 13 and the support structure. The substrate spring structure is configured to be stiff enough to hold the micro-structures in place at the perturbation and flexible enough such that the stiction force can overcome restoring force caused by the deformation of the top plate spring structure 16 and the substrate spring structure to enable the stiction plate 13 to contact the substrate 12.

To avoid unwanted stiction problems between the top plate 14 and other micro-structures, the self-tilted micromirror device 11 can further comprise at least one dimple structure disposed between the stiction plate 13 and the top plate 14 and configured to provide a space between the stiction plate 13 and the top plate 14 as will be shown in FIG. 2J. The dimple structure prevents unnecessary contact between the top plate 14 and other micro-structures of the self-tilted micromirror device 11.

The motion of the top plate 14 is determined by the contact points P between the top plate 14 and the pivot structure 15 and the contact points between the substrate 12 and stiction plate 13. To change these contact points, the geometry of the micro-structures of the self-tilted micromirror device 11 can be varied; for example, the size of the self-tilted micromirror device 11, the size, position, and number of the pivot structure 15, and so on. The linear and angular position of the top plate after the releasing process can be predetermined by the design process of the geometry of the self-tilted micromirror device 11.

FIG. 1A shows the stacked micro-structures of the self-tilted micromirror device 11 before the releasing process. The self-tilted micromirror device 11 is fabricated on the flat substrate 12. After the surface cleaning of the substrate 12, the pivot structure 15 is grown on the substrate 12. If necessary, a passivation layer can be deposited on top of the substrate 12 and the pivot structure 15. Then a first sacrificial layer S1 is overgrown on top of the substrate 12 and the pivot structure 15. The overgrown sacrificial layer S1 is then planarized by chemical mechanical polishing process. On the planarized surface, the stiction plate 13 is grown. Then, the top plate spring structure 16 can be overgrown on the same layer as that of the stiction plate 13 or on the top of the stiction plate 13. A second sacrificial layer S2 is overgrown over the stiction plate 13 and the top plate spring structure 16 and then planarized. On the planarized surface, the top plate 14 is grown. The sacrificial layers S1 and S2 are removed in the releasing process of the micro-structures. During the releasing process, the stiction plate 13 is attracted to the substrate 12 by adhesion surface forces as shown in FIG. 1B.

Although FIGS. 1A and 1B shows the simplified exemplary embodiment in order to illustrate the essential elements and brief fabrication process of the self-tilted micromirror device of the present invention, many variations in the geometry of the self-tilted micromirror device are possible. The one skilled in the art will understand that the fabrication process has to be modified depending on the geometry of the self-tilted micromirror device. For the rest of figures, the similar elements are designated with the similar numerals to those of FIG. 1.

FIGS. 2A-2J shows possible embodiments of the present invention with variation in geometry. All embodiments of the self-tilted micromirror devices 21 of the present invention comprise a substrate 22, at least one stiction plate 23 configured to be attracted to the substrate 22 by adhesion force, a top plate 24 connected to the stiction plate 23 elastically by at least one top plate spring structure 26 and configured to have at least one motion when the stiction plate 23 is attracted to the substrate 22, and at least one pivot structure 25 disposed between the substrate 22 and the top plate 24 and configured to provide a tilting point or area P for the motion of the top plate 24, wherein the motion of the top plate 24 is determined by the geometry of the micro-structures of the self-tilted micromirror device 21.

FIGS. 2A and 2B are schematic diagrams of embodiments of the present invention with variation in geometry of the top plate spring structure. The top plate spring structure can be a torsional spring structure or a flexible beam allowing the stiction plate to have a relative motion with respect to the top plate. FIG. 2A shows a self-tilted micromirror device 21 with at least one torsional spring 26s. The self-tilted micromirror device 21 further comprises at least one top plate post 26p. The torsional spring 26s can be fabricated in the same level with that of the stiction plate 23. The top plate post 26p provides a space between the stiction plate 23 and the top plate 24 and connects the top plate 24 and the torsional spring 26s. Alternatively, the top plate spring structure can be a simple flexible beam 26f connecting the stiction plate 23 and the top plate 24 as shown in FIG. 2B. Using the flexible beam 26f for the top plate spring structure, the fabrication process can become simpler and the area for the stiction plate can be increased.

FIGS. 2C and 2D are schematic diagrams of embodiments of the present invention with variation in disposition of the pivot structure. The pivot structure 25 is configured to provide a tilting point or area P for the motion of the top plate 24 when the stiction plate 23 is attracted to the substrate 22. FIG. 2C shows an exemplary embodiment, wherein the pivot structure 25 is disposed on the substrate 22. The open end of the pivot structure 25 is configured to contact the top plate 24 and served as the tilting point P for the motion of the top plate 24 when the stiction plate 23 is attracted to the substrate 22. Alternatively, the pivot structure 25 can be disposed on the top plate 24 as shown in FIG. 2D. The open end of the pivot structure 25 is configured to contact the substrate 22 (or other support structure) and served as the tilting point P for the motion of the top plate 24 when the stiction plate 23 is attracted to the substrate 22.

FIGS. 2E and 2F are schematic diagrams of embodiments of the present invention with variation in connectivity of the pivot structure. In FIG. 2E, the pivot structure 25 connects the substrate 22 and the top plate 24. The pivot structure 25 is configured to be flexible enough such that the stiction force can overcome restoring force caused by the deformation of the pivot structure 25 and the top plate spring structure 26 to enable the stiction plate 23 to contact the substrate 22. A portion of the deformed pivot structure 25 becomes a tilting point or area P for the motion of the top plate 24. Instead, the pivot structure can be configured to connect the substrate 22 and the stiction plate 23. FIG. 2F shows an exemplary embodiment of the present invention wherein the pivot structure 25 is disposed on the substrate 22 and connected to the stiction plate 23 elastically by at least one substrate spring structure 27. The open end of the pivot structure 25 is configured to contact the top plate 24 and served as the tilting point or area P for the motion of the top plate 24 when the stiction plate 23 is attracted to the top plate 24. The substrate spring structure 27 is configured to be stiff enough to hold the micro-structures in place at the perturbation and flexible enough such that the stiction force can overcome restoring force caused by the deformation of the substrate spring structure 27 and the top plate spring structure 26 to enable the stiction plate 23 to contact the substrate 22.

FIGS. 2G-2I are schematic diagrams of embodiments of the present invention further comprising at least one support structure 28. The support structures 28 looks similar to the pivot structure 25 of FIG. 2F, but has a different function from that of the pivot structure 25. While the pivot structure 25 is configured to provide a tilting point or area, the support structure 28 is configured to connect the substrate 22 and the stiction plate 23. The support structure 28 is disposed on the substrate 22 and connected to the stiction plate 23 elastically by at least one substrate spring structure 27. The substrate spring structure 27 is configured to be stiff enough to hold the micro-structures in place at the perturbation and flexible enough such that the stiction force can overcome restoring force caused by the deformation of the substrate spring structure 27 and the top plate spring structure 26 to enable the stiction plate 23 to contact the substrate 22. Also, the support structure 28 provides a space between the substrate 22 and the stiction plate 23. Longer the distance between the substrate 22 and the stiction plate 23, larger the motion (tilt angle) of the top plate 24. FIG. 2G shows a case that the pivot structure 25 is disposed on the top plate 24 and the open end of the pivot structure 25 is configured to contact the support structure 28. FIG. 2H shows a case that the pivot structure 25 is disposed on the top plate 24 and the open end of the pivot structure 25 is configured to contact the substrate 22. FIG. 2I shows a case that the pivot structure 25 is disposed on the substrate 22 and the open end of the pivot structure 25 is configured to contact the top plate 24.

FIG. 2J is a schematic diagram of one embodiment of the present invention further comprising at least one dimple structure 29 to avoid unwanted stiction problem between the top plate 24 and other micro-structures. The dimple structure 29 is disposed between the stiction plate 23 and the top plate 24 and configured to provide a space between the stiction plate 23 and the top plate 24.

Although FIGS. 2A-2J show the cases with variation in individual micro-structures, the one skilled in the art will understand that these variations can be combined to satisfy the system requirement.

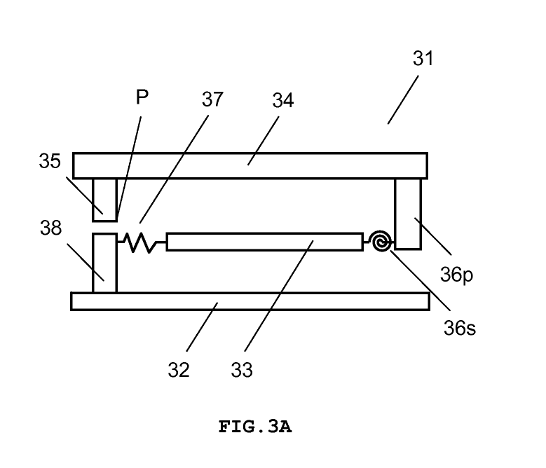

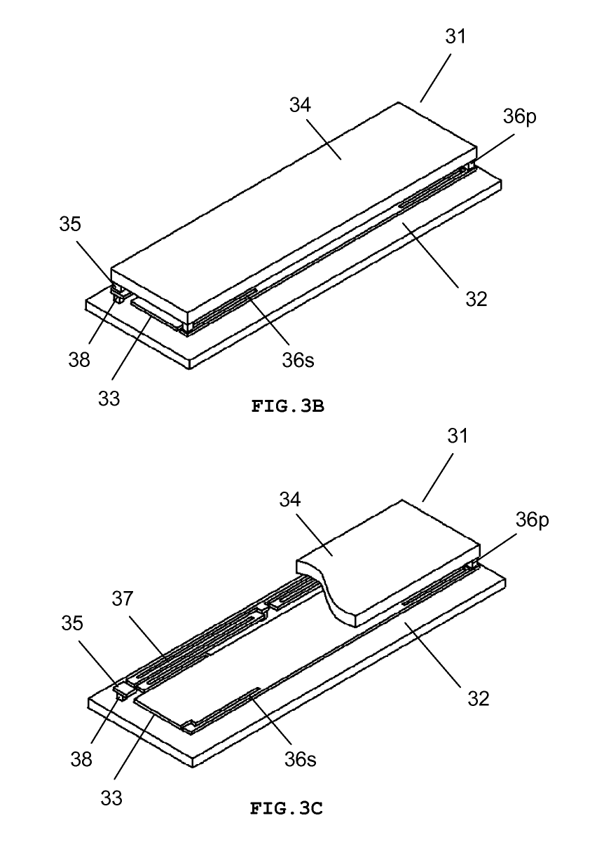

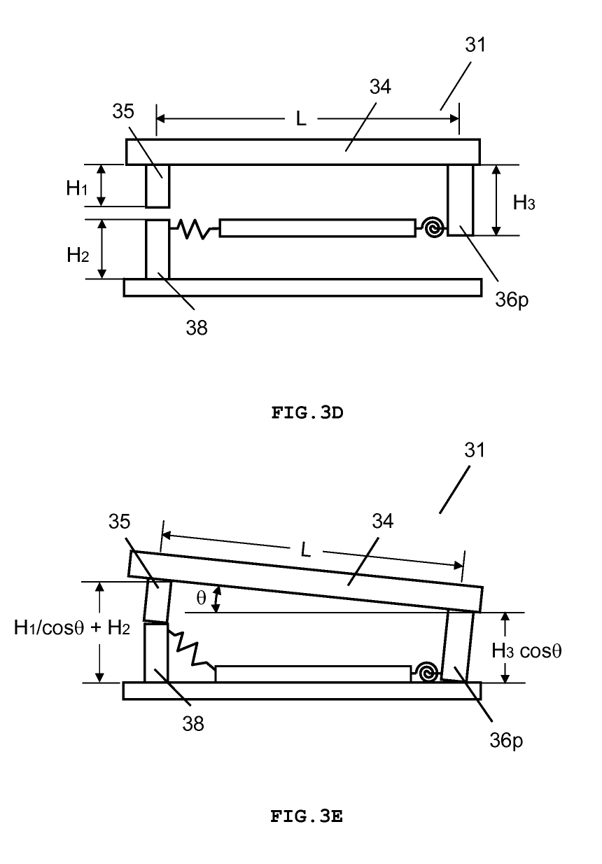

FIGS. 3A-3E are schematic diagrams of one exemplary embodiment of the present invention illustrating its structure and motion. The embodiment of FIG. 3A is used to illustrate the structure and motion of the self-tilted micromirror device of the present invention in further detail. The self-tilted micromirror device 31 of FIG. 3A comprises a plurality of micro-structures including a substrate 32, at least one stiction plate 33 configured to be attracted to the substrate 32, a top plate 34 coupled to the stiction plate 33 elastically by at least one top plate spring structure and configured to have at least one motion when the stiction plate 33 is attracted to the substrate 32, at least one support structure 38 disposed on the substrate 32 and connected to the stiction plate 33 elastically by at least one substrate spring structure 37, and at least one pivot structure 35 disposed on the top plate 34 and configured to contact the support structure 38 when the stiction plate 33 is attracted to the substrate 32. The top plate spring structure comprises at least one top plate post 36p disposed on the top plate 34 and at least one torsional spring 36s connecting the stiction plate 33 and the top plate post 36p. The motion of the top plate 34 is determined by the geometry of the micro-structures of the self-tilted micromirror device 31.

FIG. 3B is a schematic diagram of a three-dimensional view of the self-tilted micromirror device 31 and FIG. 3C is a schematic diagram of a cut away view of the self-tilted micromirror device 31. In this embodiment, several micro-structures including the stiction plate 33, the torsional spring 36s, and the substrate spring structure 37 can be fabricated in the same layer. The torsional spring 36s is configured to reduce or minimize the bending of the stiction plate 33 and/or the top plate 34. Also, the substrate spring structure 37 is configured to be stiff enough to hold the micro-structures in place at the perturbation and flexible enough such that the stiction force can overcome restoring force caused by the deformation of the substrate spring structure 37 and the torsional spring 36s to enable the stiction plate 33 to contact the substrate 32.

FIGS. 3D and 3E illustrate how the geometry of the micro-structures affects the motion of the top plate 34, wherein FIGS. 3D and 3E show the self-tilted micromirror device 31 before and after the motion of the top plate 34, respectively. The geometry of the micro-structures determines the motion of the top plate 34. In this particular embodiment, the tilt angle θ of the top plate 34 and the geometry of the micro-structures have a following relationship:

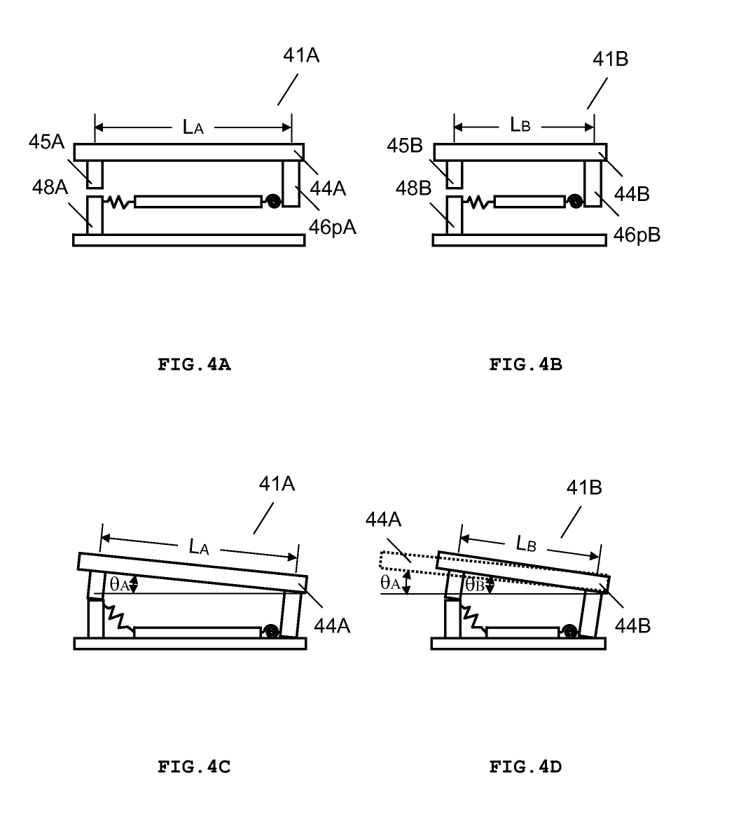

H₁+H₂ cos θ−H₃ cos² θ−L sin θ=0

where H₁ is the height of the pivot structure 35, H₂ is the height of the support structure 38, H₃ is the height of the top plate post 36p, and L is the effective width of the top plate 34. Once the required tilt angle θ is known, the dimensions of the micro-structures can be chosen so that the above constraint is satisfied. In a single self-tilted micromirror device, all the variables H₁, H₂, H₃, and L can be used as design parameters that can be chosen to obtain the required motion of the top plate 34. However, some systems may have further restrictions on choosing the dimensions of the micro-structures. For example, a system using multiple self-tilted micromirror devices may require H₁, H₂, and H₃ to be fixed for all the self-tilted micromirror devices in order to minimize the number of the fabrication processes. Then, the effective width of the top plate 34 only remains as a variable to provide the required tilt angle θ as will be shown in FIG. 4.

FIGS. 4-8 show the effects of variation in the geometry of the micro-structures. FIGS. 4A-4D shows the effects of variation in the effective size of the top plate using the embodiment of FIG. 3. Assume that two self-tilted micromirror devices 41A and 41B in FIGS. 4A and 4B have the same dimensions for H₁, H₂, and H₃, wherein H₁ is the height of the pivot structures 45A and 45B, H₂ is the height of the support structures 48A and 48B, and H₃ is the height of the top plate posts 46pA and 46ₚB. With two different effective sizes L_{A} and L_{B} of the top plates 44A and 44B, the self-tilted micromirror devices 41A and 41B can have different tilt angles θ_{A} and θ_{B} of the top plates 44A and 44B as shown in FIGS. 4C and 4D, respectively. FIG. 4D shows both the top plates 44A and 44B to show the difference between the tilt angles θ_{A} and θ_{B} of the top plates 44A and 44B, clearly. Conversely, the dimensions of the effective sizes L_{A} and L_{B} of the top plates 44A and 44B can be chosen in the design process by using geometrical constraints to obtain required tilt angles θ_{A} and θ_{B}. Obtaining the required tilt angle by changing the size of the top plate 44A and 44B is favorable for some systems forming an array of the self-tilted micromirror devices, wherein the similar micro-structures of the self-tilted micromirror devices can be fabricated in the same layer simultaneously, which allows simpler fabrication process.

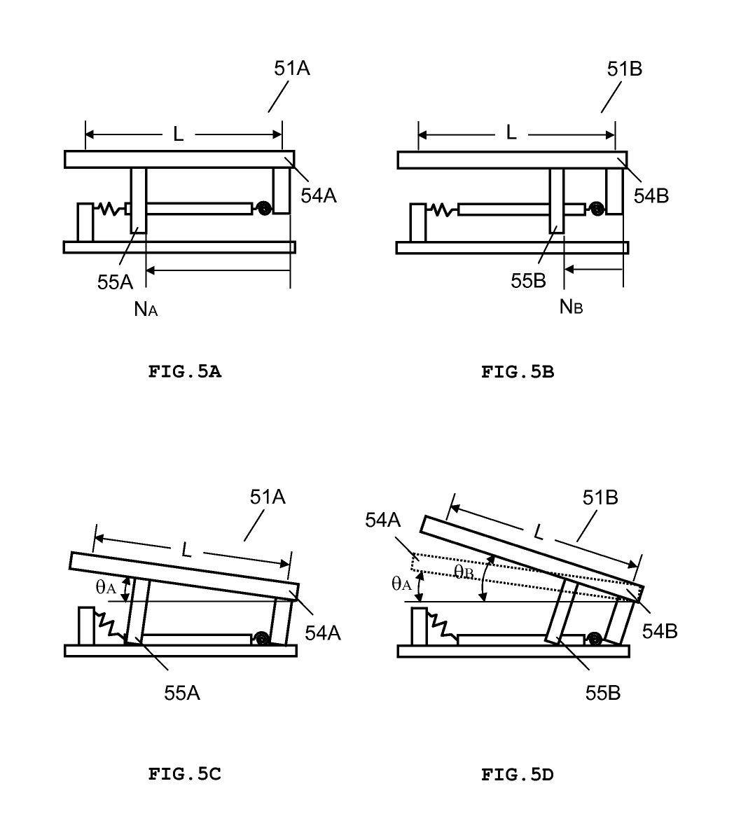

A required tilt angle of the top plate can be obtained by changing the position of the pivot structure. FIGS. 5A-5D show an example that required tilt angles are obtained by varying the position of the pivot structure using the embodiment of FIG. 2H with the top plate spring structure comprising at least one torsional spring and at least one top plate post. Assume that two self-tilted micromirror devices 51A and 51B in FIGS. 5A and 5B have the same geometry except the positions N_{A} and N_{B} of the pivot structures 55A and 55B on the top plates 54A and 54B. By positioning the pivot structures 55A and 55B in two different positions N_{A} and N_{B}, the self-tilted micromirror devices 51A and 51B can have different tilt angles θ_{A} and θ_{B} of the top plates 54A and 54B as shown in FIGS. 5C and 5D, respectively. FIG. 5D shows both the top plates 54A and 54B to show the difference between the tilt angles θ_{A} and θ_{B} of the top plates 54A and 54B, clearly. Conversely, the positions N_{A} and N_{B} of the pivot structures 55A and 55B can be chosen in the design process by using geometrical constraints to obtain required tilt angles θ_{A} and θ_{B}. Obtaining the required tilt angle by changing the position N_{A} and N_{B} of the pivot structure 55A and 55B is favorable for some systems forming an array of the self-tilted micromirror devices, wherein the similar micro-structures of the self-tilted micromirror devices can be fabricated in the same layer simultaneously, which allows simpler fabrication process. Also, unlike the case of FIG. 4, all top plates in the array can have the identical size L while having different tilt angles.

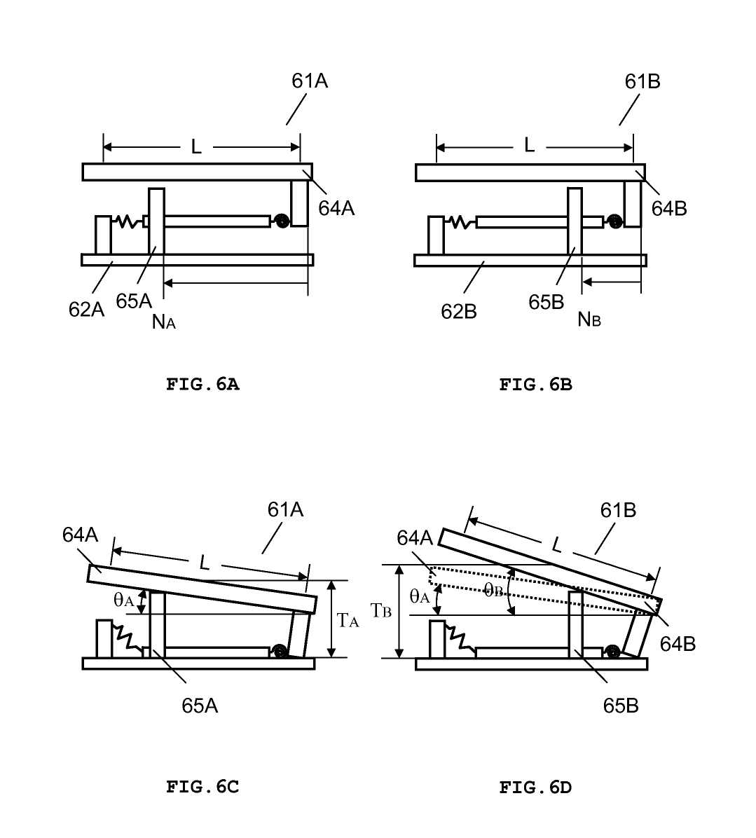

FIGS. 6A-6D show another example that required tilt angles are obtained by varying the position of the pivot structure using the embodiment of FIG. 21 with the top plate spring structure comprising at least one torsional spring and at least one top plate post. Assume that two self-tilted micromirror devices 61A and 61B in FIGS. 6A and 6B have the same geometry except the positions N_{A} and N_{B} of the pivot structures 65A and 65B on the substrate 62A and 62B. By positioning the pivot structures 65A and 65B in two different positions N_{A} and N_{B}, the self-tilted micromirror devices 61A and 61B can have different tilt angles θ_{A} and θ_{B} Of the top plates 64A and 64B as shown in FIGS. 6C and 6D, respectively. FIG. 6D shows both the top plates 64A and 64B to show the difference between the tilt angles θ_{A} and θ_{B} of the top plates 64A and 64B, clearly. Conversely, the positions N_{A} and N_{B} of the pivot structures 65A and 65B can be chosen in the design process by using geometrical constraints to obtain required tilt angles θ_{A} and θ_{B}. Obtaining the required tilt angle by changing the position N_{A} and N_{B} of the pivot structure 65A and 65B is favorable for some systems forming an array of the self-tilted micromirror devices, wherein the similar micro-structures of the self-tilted micromirror devices can be fabricated in the same layer simultaneously, which allows simpler fabrication process. Also, unlike the case of FIG. 4, all top plates in the array can have the identical size L while having different tilt angles.

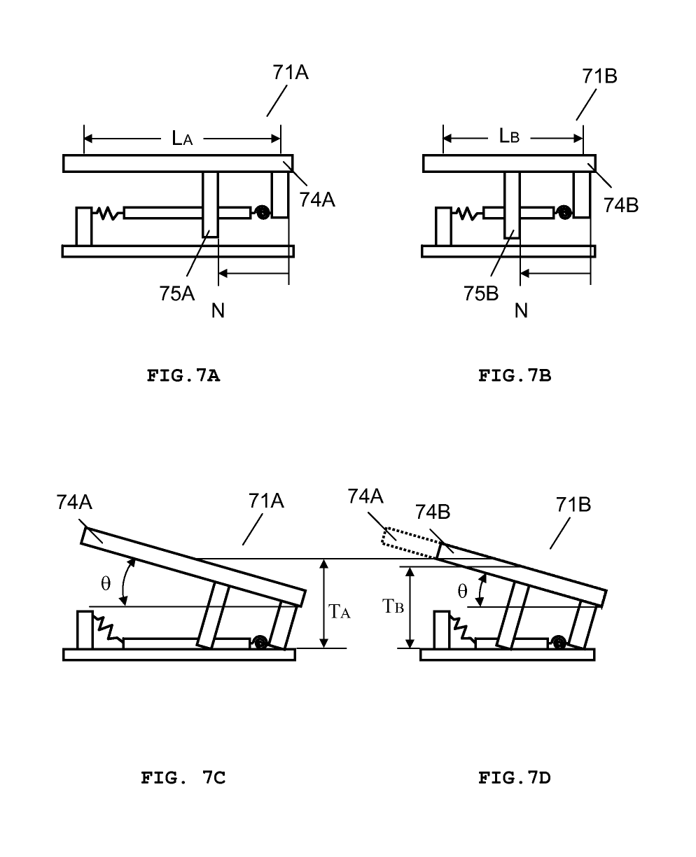

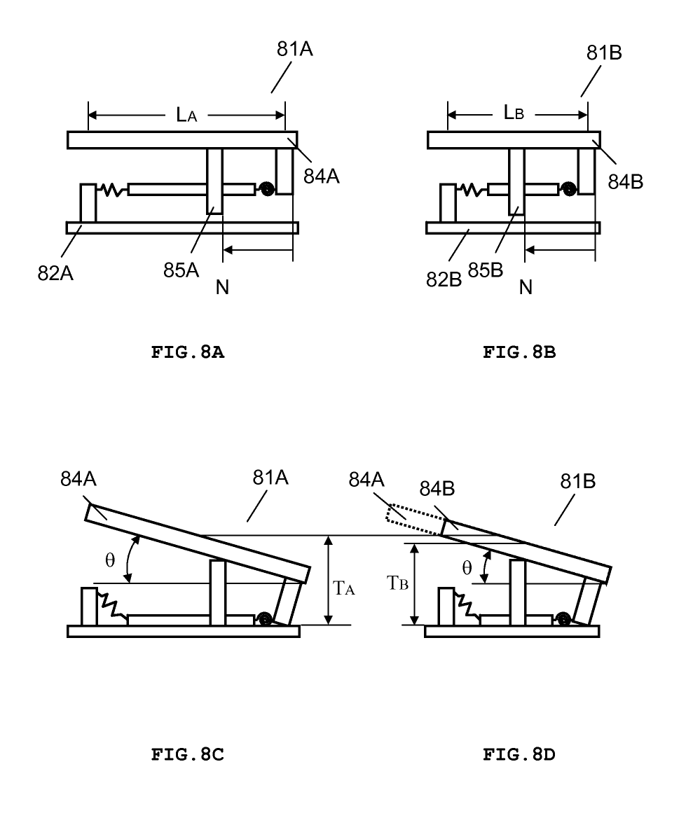

As the result of tilt of the top plate, the top plate can have translational (linear) motion as well as rotational (angular) motion. For example, the top plates 64A and 64B can have different linear positions T_{A} and T_{B} as shown in FIGS. 6C and 6D. However, in this case, the translational motion and the rotational motion of the top plate are coupled each other so it is difficult to make the top plate have required translational motion and rotational motion together. This problem can be resolved by introducing more design parameters. FIGS. 7 and 8 show exemplary embodiments capable of providing the top plate with independent translational motion and rotational motion. FIGS. 7A-7D show two self-tilted micromirror devices 71A and 71B providing the top plates 74A and 74B with independent translational motion and rotational motion using the embodiment of FIG. 2H. The rotational motion is varied by changing the position of the pivot structure 75A and 75B on the top plates 74A and 74B and the translational motion is varied by changing the size of the top plates 74A and 74B. In this example, two self-tilted micromirror devices have the same positions N of the pivot structures 75A and 75B and different sizes L_{A} and L_{B} of the top plates 74A and 74B to show independent translational motion. Therefore, the two self-tilted micromirror devices 71A and 71B have the same tilt angle θ of the top plates 74A and 74B but different linear positions T_{A} and T_{B}, of the top plates 74A and 74B, respectively. FIG. 7D shows both the top plates 74A and 74B to show the difference between the linear positions T_{A} and T_{B} of the top plates 74A and 74B, clearly.

FIGS. 8A-8D show two self-tilted micromirror devices 81A and 81B providing the top plates 84A and 84B with independent translational motion and rotational motion using the embodiment of FIG. 2I. The rotational motion is varied by changing the position of the pivot structure 85A and 85B on the substrate 82A and 82B and the translational motion is varied by changing the size of the top plates 84A and 84B. In this example, two self-tilted micromirror devices have the same positions N of the pivot structures 85A and 85B and different sizes L_{A} and L_{B} of the top plates 84A and 84B to show independent translational motion. Therefore, the two self-tilted micromirror devices 81A and 81B have the same tilt angle θ of the top plates 84A and 84B but different linear positions T_{A} and T_{B} of the top plates 84A and 84B, respectively. FIG. 8D shows both the top plates 84A and 84B to show the difference between the linear positions T_{A} and T_{B} of the top plates 84A and 84B, clearly.

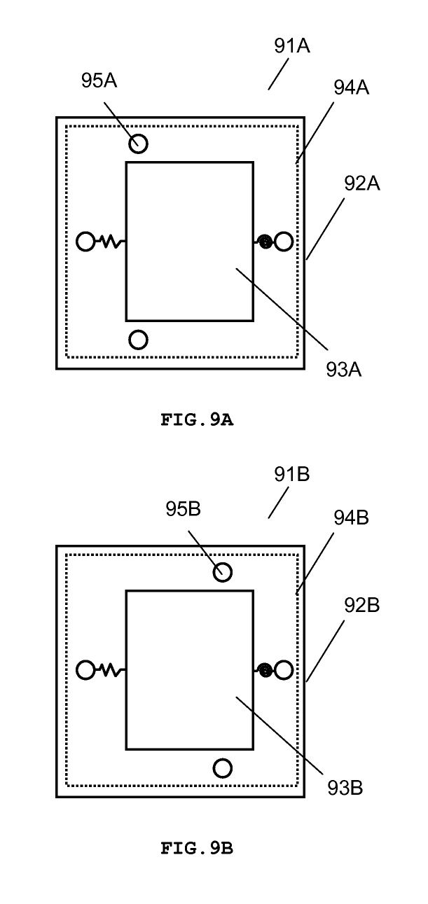

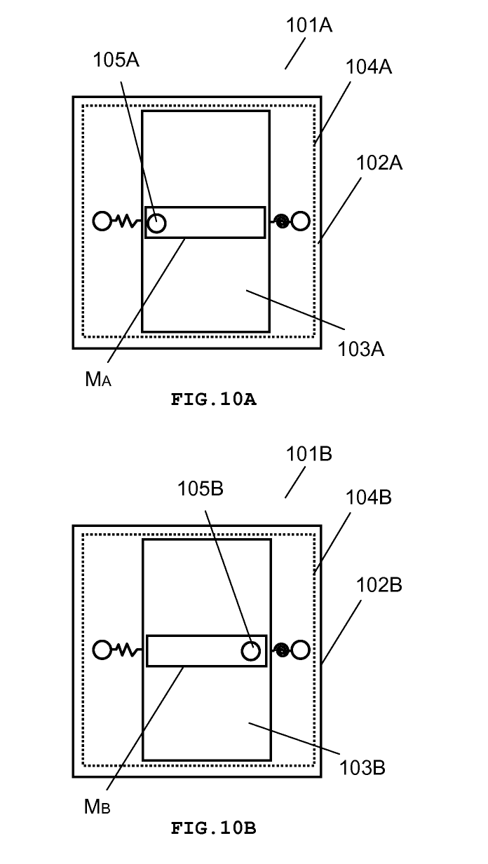

As in the cases of FIGS. 5-8, the position of the pivot structure can be used as one of design parameters to provide a required motion of the top plate. Depending on the position of the pivot structure, some structural modification may be required so that the motions of the pivot structure and the stiction plate do not hinder the movements of each other. Especially, for the array of the self-tilted micromirror devices, it is desirable that each self-tilted micromirror device has more common identical micro-structures to simplify the design process and fabrication. FIGS. 9 and 10 are schematic diagrams of the top view of the self-tilted micromirror devices showing possible configurations of the pivot structures and the stiction plates. In FIGS. 9A and 9B, two self-tilted micromirror devices 91A and 91B have common identical micro-structures except the position of the pivot structure 95A and 95B as shown in the embodiments of FIGS. 5-8. The pivot structures 95A and 95B can be disposed on the outer rims of the top plates 94A and 94B or the substrates 92A and 92B as shown in FIG. 9 so that the stiction plates 93A and 93B and the pivot structures 95A and 95B do not hinder the movements of each other, respectively. Alternatively, the stiction plates 103A and 103B can be configured to have at least one hole M_{A} and M_{B} so that the pivot structure 105A and 105B can contact the substrates 102A and 102B or the top plates 104A and 104B through the holes M_{A} and M_{B} as shown in the self-tilted micromirror devices 101A and 101B of FIG. 10, respectively.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A self-tilted micromirror device comprising:
a) a substrate;
b) at least one stiction plate configured to be attracted to the substrate by adhesion force;
c) a top plate coupled to the stiction plate elastically and configured to have at least one motion when the stiction plate is attracted to the substrate; and
d) at least one pivot structure disposed between the substrate and the top plate and configured to provide a tilting point or area for the motion of the top plate;
wherein the motion of the top plate is determined by the geometry of the micro-structures of the self-tilted micromirror device.

2. The self-tilted micromirror device of the claim 1, wherein the motion of the top plate is determined by the size of the top plate.

3. The self-tilted micromirror device of the claim 1, wherein the motion of the top plate is determined by the size and position of the pivot structure.

4. The self-tilted micromirror device of the claim 1, wherein the top plate is coupled to the stiction plate elastically by at least one top plate spring structure.

5. The self-tilted micromirror device of the claim 4, further comprising at least one top plate post configured to provide a space between the top plate and the stiction plate and connecting the top plate and the top plate spring structure.

6. The self-tilted micromirror device of the claim 1, further comprising at least one support structure disposed on the substrate and connected to the stiction plate elastically.

7. The self-tilted micromirror device of the claim 6, further comprising at least one substrate spring structure connecting the stiction plate and the support structure.

8. The self-tilted micromirror device of the claim 1, wherein the pivot structure is disposed on the substrate and configured to contact the top plate when the stiction plate is attracted to the substrate.

9. The self-tilted micromirror device of the claim 1, wherein the pivot structure is disposed on the top plate and configured to contact the substrate when the stiction plate is attracted to the substrate.

10. The self-tilted micromirror device of the claim 6, wherein the pivot structure is disposed on the top plate and configured to contact the support structure when the stiction plate is attracted to the substrate.

11. The self-tilted micromirror device of the claim 6, wherein the support structure is the pivot structure configured to contact the top plate when the stiction plate is attracted to the substrate.

12. The self-tilted micromirror device of the claim 1, wherein the adhesion force is caused by capillary action of the liquid used in the releasing process of the micro-structures.

13. The self-tilted micromirror device of the claim 1, wherein the adhesion force is adhesion surface force.

14. The self-tilted micromirror device of the claim 1, wherein the adhesion force is der Waals force.

15. The self-tilted micromirror device of the claim 1, wherein the adhesion force is caused by atomic bonding.

16. The self-tilted micromirror device of the claim 1, wherein the adhesion force is electrostatic force by residual charge.

17. The self-tilted micromirror device of the claim 1, wherein the stiction plate is attracted to the substrate in the releasing process of the micro-structures.

18. The self-tilted micromirror device of the claim 1, wherein the stiction plate is attracted to the substrate in the initial operation of the self-tilted micromirror device.

19. The self-tilted micromirror device of the claim 1, wherein the linear and angular position of the top plate remains fixed by the adhesion force after the motion of the top plate.

20. The self-tilted micromirror device of the claim 1, further comprising at least one dimple disposed between the top plate and the substrate and configured to provide a space between the top plate and the stiction plate.

21. A self-tilted micromirror device comprising:
a) a substrate;
b) at least one stiction plate configured to be attracted to the substrate by adhesion force;
c) a top plate configured to have at least one motion when the stiction plate is attracted to the substrate;
d) at least one top plate post configured to provide a space between the top plate and the stiction plate;
e) at least one top plate spring structure connecting the stiction plate and the top plate post; and
d) at least one pivot structure disposed between the substrate and the top plate and configured to provide a tilting point or area for the motion of the top plate;
wherein the motion of the top plate is determined by the geometry of the micro-structures.

22. A self-tilted micromirror device comprising:
a) a substrate;
b) at least one stiction plate configured to be attracted to the substrate by adhesion force;
c) a top plate coupled to the stiction plate elastically and configured to have at least one motion when the stiction plate is attracted to the substrate; and
d) at least one pivot structure connecting the substrate and the top plate and configured to be bent and provide a tilting point or area for the motion of the top plate;
wherein the motion of the top plate is determined by the geometry of the micro-structures.

23. A self-tilted micromirror device comprising:
a) a substrate;
b) at least one stiction plate configured to be attracted to the substrate by adhesion force;
c) a top plate coupled to the stiction plate elastically and configured to have at least one motion when the stiction plate is attracted to the substrate;
d) at least one pivot structure disposed between the substrate and the top plate and configured to provide a tilting point or area for the motion of the top plate; and
e) at least one support structure disposed on the substrate and connected to the stiction plate by at least one substrate spring structure;
wherein the motion of the top plate is determined by the geometry of the micro-structures.

24. A self-tilted micromirror device comprising:
a) a substrate;
b) at least one stiction plate configured to be attracted to the substrate by adhesion force;
c) a top plate connected to the stiction plate by at least one top plate spring structure and configured to have at least one motion when the stiction plate is attracted to the substrate;
d) at least one pivot structure disposed between the substrate and the top plate and configured to provide a tilting point or area for the motion of the top plate; and
e) at least one support structure disposed on the substrate and connected to the stiction plate by at least one substrate spring structure;
wherein the motion of the top plate is determined by the geometry of the micro-structures.

25. A self-tilted micromirror device comprising:
a) a substrate;
b) at least one stiction plate configured to be attracted to the substrate by adhesion force;
c) a top plate coupled to the stiction plate elastically and configured to have at least one motion when the stiction plate is attracted to the substrate;
d) at least one pivot structure disposed between the substrate and the top plate and configured to provide a tilting point or area for the motion of the top plate;
e) at least one support structure disposed on the substrate and connected to the stiction plate by at least one substrate spring structure; and
f) at least one dimple structure disposed between the substrate and the top plate and configured to provide a space between the stiction plate and the top plate;
wherein the motion of the top plate is determined by the geometry of the micro-structures.
